(19) United States
(12) Patent Application Publication
(10) Pub. No.: US 2013/0286299 A1
(43) Pub. Date: Oct. 31, 2013

(54) TELEVISION RECEIVER AND ELECTRONIC DEVICE

(71) Applicant: KABUSHIKI KAISHA TOSHIBA, Tokyo (JP)

(72) Inventor: Yuki SATO, Tokyo (JP)

(73) Assignee: KABUSHIKI KAISHA TOSHIBA, Tokyo (JP)

(21) Appl. No.: 13/670,401

(22) Filed: Nov. 6, 2012

(30) Foreign Application Priority Data
Apr. 27, 2012 (JP) 2012-103520

(51) Int. Cl. H04N 5/64

(52) U.S. Cl. 348/839; 348/E05.128

(57) ABSTRACT

According to one embodiment, a television receiver includes: a housing; a module; and a module. The housing includes a first wall including a first opening configured to allow an engaging member of a connecting device to pass through. The module is removably housed in a container in the housing. The module includes a second wall overlapping with the first wall. The module includes a second opening overlapping with the first opening. The module allows the engaging member to pass through. The housing allows the engaging member to be locked in the housing in a state in which the connecting device is connected to the housing and the module is housed in the container.

### CROSS-REFERENCE TO RELATED APPLICATIONS

This application is based upon and claims the benefit of priority from Japanese Patent Application No. 2012-103520, filed on Apr. 27, 2012, the entire contents of which are incorporated herein by reference.

### FIELD

Embodiments described herein relate generally to a television receiver and an electronic device.

### BACKGROUND

Conventionally, there is known an electronic device to which a connecting device can be attached for preventing a housing from being moved and preventing a module from being removed from the housing.

There exist also electronic devices to which the conventional connecting device is difficult to be applied.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary front view of a television receiver according to a first embodiment;

FIG. 2 is an exemplary side view of the television receiver in the first embodiment;

FIG. 3 is an exemplary schematic cross-sectional view taken along line III-III of FIG. 1, in the first embodiment;

FIG. 4 is an exemplary schematic cross-sectional view taken along line IV-IV of FIG. 1, in the first embodiment;

FIG. 5 is an exemplary perspective view of an electronic device as viewed from a front side, according to a second embodiment;

FIG. 6 is an exemplary perspective view of the electronic device as viewed from a rear side, in the second embodiment;

FIG. 7 is an exemplary perspective view of the electronic device from which a first module is removed, as viewed from the rear side, in the second embodiment;

FIG. 8 is an exemplary schematic cross-sectional view taken along line VIII-VIII of FIG. 6, in the second embodiment;

FIG. 9 is an exemplary rear view of a second housing of an electronic device according to a third embodiment;

FIG. 10 is an exemplary schematic cross-sectional view taken along line X-X of FIG. 9, in the third embodiment;

FIG. 11 is an exemplary schematic cross-sectional view of an electronic device and a first module, taken at a position the same as that of FIG. 8, according to a fourth embodiment;

FIG. 12 is an exemplary perspective view of an electronic device as viewed from a rear side, according to a fifth embodiment;

FIG. 13 is an exemplary cross-sectional view taken along line XIII-XIII of FIG. 12, in the fifth embodiment;

FIG. 14 is an exemplary schematic cross-sectional view taken along line XIV-XIV of FIG. 12, in the fifth embodiment;

FIG. 15 is an exemplary schematic exploded cross-sectional view taken along line XIV-XIV of FIG. 12, in the fifth embodiment;

FIG. 16 is an exemplary schematic plan view (partially cross-sectional view) of inside a second housing of an electronic device according to a sixth embodiment;

FIG. 17 is an exemplary view of a holder of a second module in the electronic device as viewed in an arrow IVII direction in FIG. 16, in the sixth embodiment;

FIG. 18 is an exemplary schematic plan view (partially sectional view) of inside a second housing of an electronic device according to a seventh embodiment;

FIG. 19 is an exemplary schematic plan view (partially sectional view) of inside a second housing of an electronic device according to an eighth embodiment;

FIG. 20 is an exemplary schematic plan view (partially sectional view) of inside a second housing of an electronic device according to a ninth embodiment;

FIG. 21 is an exemplary schematic plan view (partially sectional view) of inside a second housing of an electronic device according to a tenth embodiment;

FIG. 22 is an exemplary schematic plan view (partially sectional view) of inside a second housing of an electronic device according to an eleventh embodiment;

FIG. 23 is an exemplary schematic plan view (partially sectional view) of inside a second housing of an electronic device according to a twelfth embodiment;

FIG. 24 is an exemplary schematic plan view (partially sectional view) of inside a second housing of an electronic device according to a thirteenth embodiment; and

FIG. 25 is an exemplary schematic plan view (partially sectional view) of inside a second housing of an electronic device according to a fourteenth embodiment.

### DETAILED DESCRIPTION

In general, according to one embodiment, a television receiver comprises a housing and a module. The housing comprises a first wall comprising a first opening configured to allow an engaging member of a connecting device to pass through. The module is removably housed in a container in the housing. The module comprises a second wall overlapping with the first wall. The module comprises a second opening overlapping with the first opening. The module is configured to allow the engaging member to pass through. The housing is configured to allow the engaging member to be locked in the housing in a state in which the connecting device is connected to the housing and the module is housed in the container.

A plurality of exemplary embodiments, which will be described below, comprise the same components. In the following, the same components are represented with common reference numerals, and the repeated explanations thereof are omitted.

The following embodiments exemplify cases in which an electronic device is configured as a television receiver or a so-called laptop (clamshell) personal computer. However, the electronic devices in the embodiments are not limited thereto. The electronic devices in the embodiments can be configured as an electronic device having a removal module, more concretely as a so-called desktop or tablet (slate) personal computer, a Smart TV, or an image display device, for example.

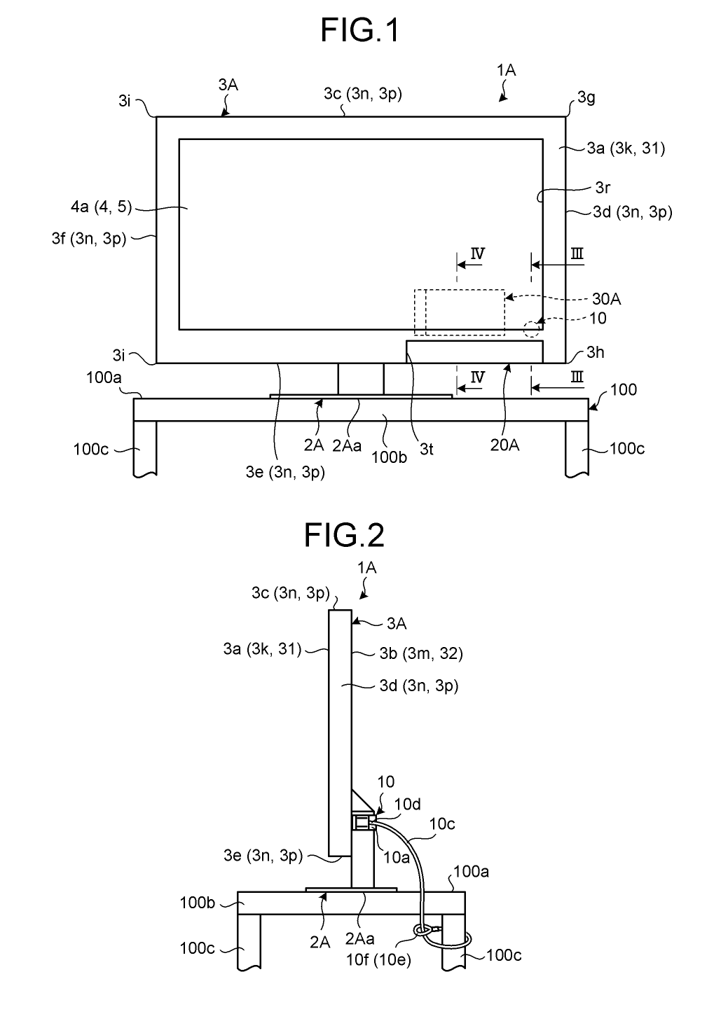

In the first embodiment, as an example, a television receiver 1A (an electronic device) comprises a support portion 2A and a housing 3A, as illustrated in FIGS. 1 and 2. To be more specific, the housing 3A houses at least a portion of a display device 4. The support portion 2A (a stand, a base, a leg) supports the housing 3A. The support portion 2A has an area 2Aa (a bottom wall, a wall, an area, a portion, a leg) facing (in contact with) an external carrying face 100a (an external carrying base 100, a top plate 100b) when put on the external carrying face 100a. The support portion 2A can support the housing 3A in a movable manner (rotatable manner). In this case, the motion of the housing 3A is of tilt, pivot, swivel, etc.

In the first embodiment, as an example, the housing 3A is quadrangular (rectangular as an example in the first embodiment) in a front view and a rear view, as illustrated in FIG. 1. In the first embodiment, as an example, the housing 3A is thin flat rectangular parallelepiped in a front-back direction, as illustrated in FIG. 2. The housing 3A has a face 3a (a faces anterior, an upper face, a front face, a face portion), and a opposite face 3b (a back face, an under face, a rear face, a face portion). The face 3a and the face 3b are nearly parallel. As illustrated in FIG. 1, in a front view, the housing 3A has four ends 3c to 3f (sides, edges), and four corners 3g to 3j (apexes, curves, ends). The ends 3c and 3e are examples of long sides, while the ends 3d and 3f are examples of short sides.

The housing 3A has a wall 3k (a portion, a plate, a frame, a front wall, a surface wall, a top wall) having the face 3a, and a wall 3m (a portion, a plate, a back wall, a rear wall, a bottom wall) having the face 3b, as an example. The walls 3k and 3m are quadrangular (rectangular as an example in the first embodiment). The housing 3A has four walls 3n (portions, plates, side walls, end walls, standing walls, extending portions) that have a face 3p (a side face, a periphery face) extending between the wall 3k and the wall 3m. The wall 3k is provided with a quadrangular opening 3r, for example. Therefore, the wall 3k is quadrangular and is of frame.

The housing 3A can be constituted by a combination of a plurality of components (divided bodies). In the first embodiment, as an example, the housing 3A comprises a first housing member 31 (a first portion, a front-side member, a mask, a mask portion, a cover, a front cover, a cover portion, a first area) having at least the wall 3k, and a second housing member 32 (a second portion, a back-side member, abase, abase portion, a bottom, a bottom portion, a cover, a rear cover, a cover portion, a second area) having at least the wall 3m. The walls 3n are included in at least one of the first housing member 31 and the second housing member 32 (in the second housing member 32, for example). Separately from the first housing member 31 and the second housing member 32, the housing 3A can comprise a third housing member (a third portion, an intermediate member, a spacing member, a barrier member, a wall member, an interposed member, an inner plate, a middle plate, a middle frame, a third area (not illustrated)), a fourth housing member (a fourth portion, an intermediate member, a spacing member, a barrier member, a wall member, an interposed member, a cover member, a shield, a fourth area (not illustrated)), and other members that are interposed between the housing members 31, 32. The housing 3A can be formed of metallic or synthetic resin material, for example. Inside of the housing 3A such as in the first housing member 31 and the second housing member 32, walls such as ribs (projecting portions, projecting walls (not illustrated)) can be provided. These walls make the housing 3A more rigid.

In the first embodiment, as an example, the faces 3b and 3p, etc., of the housing 3A can be provided with a connecter, an operation portion, etc. (not illustrated). The connector may be a connector for a power cable, a universal serial bus (USB) connector, a card connector, or a connector for earphones or a microphone, for example. The operation portion may be of a push button, a push switch, a slide switch, a pointing device, or a dial, for example. The face 3a can be provided with a camera module (a camera, an imaging device (not illustrated)).

In the first embodiment, as an example, a display screen 4a positioned on a side of the face 3a of the display device 4 (a display portion, a display, a panel) is exposed to the front side (outside) of the housing 3A through the opening 3r, as illustrated in FIG. 1. A user, for example, can visually recognize the display screen 4a through the opening 3r from the front side. The display device 4 is quadrangular (rectangular as an example in the first embodiment) in a front view. The display device 4 is thin flat rectangular parallelepiped in a front-back direction. The display device 4 is a liquid crystal display (LCD), or an organic electro-luminescent display (GELD), for example.

In the first embodiment, as an example, on the front side (the surface side, the side of the wall 3k) of the display device 4, a touch panel 5 (an input operation panel, a touch sensor, an operation face, a cover, for example) is provided. The touch panel 5 is transparent relatively-thin quadrangular, and covers the display screen 4a. A user, for example, touches, pushes, rubs the touch panel 5 with a finger, a piece (a stylus, for example (not illustrated)), or moves a finger, a stylus, etc., in the vicinity of the touch panel 5, for example, so as to perform input processing. The light emitted from the display screen 4a of the display device 4 passes through the touch panel 5, and is then let out to the front side (outside) of the housing 3A through the opening 3r of the wall 3k.

In the first embodiment, as an example, the housing 3A houses, on the back side (the reverse side, the rear side, the side of the wall 3m, the side opposite to the display screen 4a) of the display device 4, one or more substrate (a circuit board, a control board, a main board, an electrical component, a component (not illustrated)). The substrate is provided in parallel with the display device 4. The substrate is positioned to be spaced apart from the walls 3k, 3m, 3n, etc., that is, the substrate is provided with space (gaps) with respect to the walls 3k, 3m, 3n, etc.

In the first embodiment, as an example, a plurality of components (not illustrated) such as a central processing unit (CPU), a graphic controller, power circuit parts, a plat form controller hub (PCH), a memory slot connector, an LCD connector, an input/output (I/O) connector, a power coil, an element, and a connector, can be mounted on the substrate. A control circuit can comprise an image signal processing circuit, a tuner, a high-definition multimedia interface (HDMI) signal processor, an audio video (AV) input terminal, a remote control signal receiving module, a controller, a selector, an on-screen display interface, a memory (a read only memory (ROM), a random access memory (RAM), a hard disk drive (HDD), a solid state drive (SSD), for example), a voice signal processing circuit, etc. The control circuit controls the output of images (moving images, still images, etc.) on the display screen 4a of the display device 4, the output of voice from a speaker (not illustrated), the emission of light from a light emitting diode (LED), etc. The display device 4, the speaker, the LED, etc., are examples of an output module.

In the first embodiment, as an example, the housing 3A is provided with a container 3t, as illustrated in FIGS. 1, 3 and 4. To be more specific, the container 3t is provided, at the end 3e (the lower end portion) of the housing 3A, as a notch open toward the side of the external carrying face 100a (downward). The container 3t extends along the end 3e. The container 3t houses a battery module 20A (a module, a first module) in a removable manner. The battery module 20A is rectangular parallelepiped (of square bar) extending along the end 3e. In the first embodiment, as an example, the battery module 20A can be attached to the container 3t by moving (inserting) the battery module 20A from the lower side to the upper side in FIGS. 1 to 4, and can be removed from the container 3t by moving the battery module 20A from the upper side to the lower side in FIGS. 1 to 4. At least any one of the container 3t (housing 3A) and the battery module 20A is provided with a structure for guiding the battery module 20A to a given position (an attached position) in the container 3t, a lock structure for locking the battery module 20A at the given position, and a lock cancel structure for cancelling a lock by the lock structure (any of which are not illustrated).

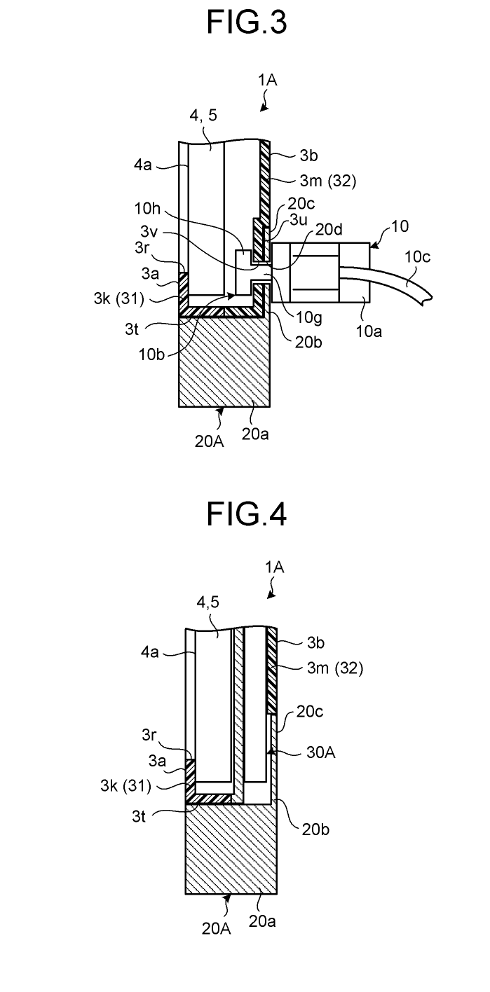

In the first embodiment, as an example, a well-known connecting device 10 (a lock device, an anti-movement device, an anti-theft device) can be attached to the housing 3A, as illustrated in FIGS. 2 and 3. The connecting device 10 comprises a housing 10a (a support portion, a body, a body portion, a fixing portion, a first portion), a connecting member 10b (an engaging member, a lock member, a hook member, a key member, a member, a movable portion, a second portion), and a wire 10c, for example. One end 10d of the wire 10c is fixed to the housing 10a. On the other end 10e of the wire 10c, an annular portion 10f (a ring portion) is provided. In the first embodiment, as an example, the end 10d of the housing 10a and the wire 10c is wound around a leg 100c of the external carrying base 100, guided through the annular portion 10f, and then connected to the housing 3A, as illustrated in FIG. 2. Therefore, the television receiver 1A to which the connecting device 10 is attached to the housing 3A in the way as illustrated in FIG. 2 cannot be moved farther than a position to which the wire 10c is extended. That is, the connecting device 10 can prevent the movement (unwilling movement, or theft, for example) of the television receiver 1A.

In the first embodiment, as an example, a wall 20b (a flange portion, a projecting portion, a second wall) extending from a housing 20a (a support portion, a body, a body portion, a first portion) of the battery module 20A is overlapped on the outside (the outside of the housing, the rear side) of the wall 3m of the housing 3A, as illustrated in FIG. 3. The wall 3m (a first wall) is provided with a depressed portion 3u (a container, a step) housing the wall 20b. With this arrangement, there exist hardly a level difference between the face 3b and a face 20c. Opening portions 3v (a first opening) and 20d (a second opening) through which the connecting member 10b is passed are provided at a portion where the wall 3m and the wall 20b overlap each other. The connecting member 10b is configured in T-form or L-form (T-form as an example in the first embodiment), and has a shaft 10g (an arm portion) extended from the housing 10a, and a pawl 10h (a hook portion) at the head side of the shaft 10g. The opening portions 3v and 20d are arranged in long slotted form along the end 3e. The pawl 10h of the connecting member 10b is passed through the long slotted opening portions 3v and 20d, and then rotated by 90°, for example, with the shaft 10g as a center. This allows a state in which the walls 3m and 20b are sandwiched between the housing 10a and the pawl 10h, that is, a state in which the connecting device 10 is connected and locked to the housing 3A, as illustrated in FIG. 3. The walls 3m and 20b are examples of an engaging portion (a support portion, an engage portion, a return-preventing portion). The rotation (the variation of posture) of the housing 10a relative to the housing 3A is prevented in a state that the connecting device 10 is connected and locked to the housing 3A. A user, for example, inserts a key (not illustrated) into the housing 10a from the side opposite (the rear of) the connecting member 10b and turns the key so that the connecting member 10b can be rotated (locked). In addition, a user, for example, turns the key so that the connection (lock) of the connecting device 10 to the housing 3A can be cancelled (unlocked).

In the first embodiment, as an example, the housing 3A houses a second module 30A (a hard disk drive (HDD) module, a solid state drive (SSD) module, an optical disk drive (ODD) module, etc., (an HDD module as an example in the first embodiment)) in a removable manner. The second module 30A is an electrical component (an electronic component), and is electrically connected to the substrate (not illustrated) in the housing 3A in a manner that connecters (not illustrated) are electrically connected to each other. Here, in the first embodiment, as an example, a portion of the second module 30A is covered by a portion of the battery module 20A, as illustrated in FIG. 4. Therefore, in the first embodiment, as an example, the battery module 20A housed in the container 3t can prevent the second module 30A from coming out the housing (housing 3A). That is, in the first embodiment, as an example, unless the battery module 20A is taken out from the container 3t, the second module 30A cannot be taken out from the housing (housing 3A). As described above, unless the connecting device 10 is removed from the housing 3A, the battery module 20A cannot be taken out from the container 3t. Therefore, in the first embodiment, as an example, the connecting device 10 locks not only the battery module 20A but also the second module 30A to the housing 3A.

As described above, in the first embodiment, as an example, the openings 3v and 20d are provided at a portion where the wall 3m of the housing 3A and the wall 20b of the battery module 20A positioned outside of the housing of the wall 3m overlap each other. The connecting member 10b passes through the openings 3v and 20d, so that the connecting device 10 is connected to the housing 3A, and locked thereto in a state in which the battery module 20A is housed in the container 3t. In addition, the second module 30A is locked (fixed) to the housing 3A. Therefore, in the first embodiment, as an example, it is possible, with the connecting device 10, to achieve a structure for preventing the movement of the housing 3A and preventing the battery module 20A and the second module 30A from being removed from (coming off) the housing as a relatively simple structure. In the first embodiment, as an example, if a portion overlapping with the wall 3m of the housing 3A (the wall 20b as an example in the first embodiment) can be provided to the battery module 20A, the openings 3v and 20d overlapping each other can be provided, and space for housing the connecting member 10b can be provided inside of the walls 3m and 20b, the above-mentioned effects by the connecting device 10 can be obtained. Thus, as an example, it is easier to increase the degree of freedom of layout of the connecting device 10 and the other components in the housing 3A.

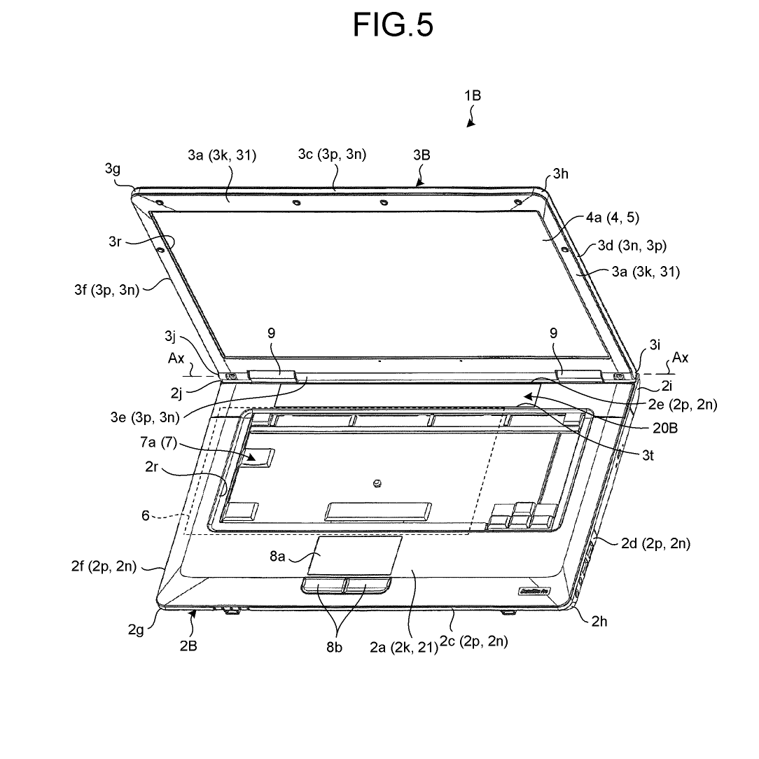

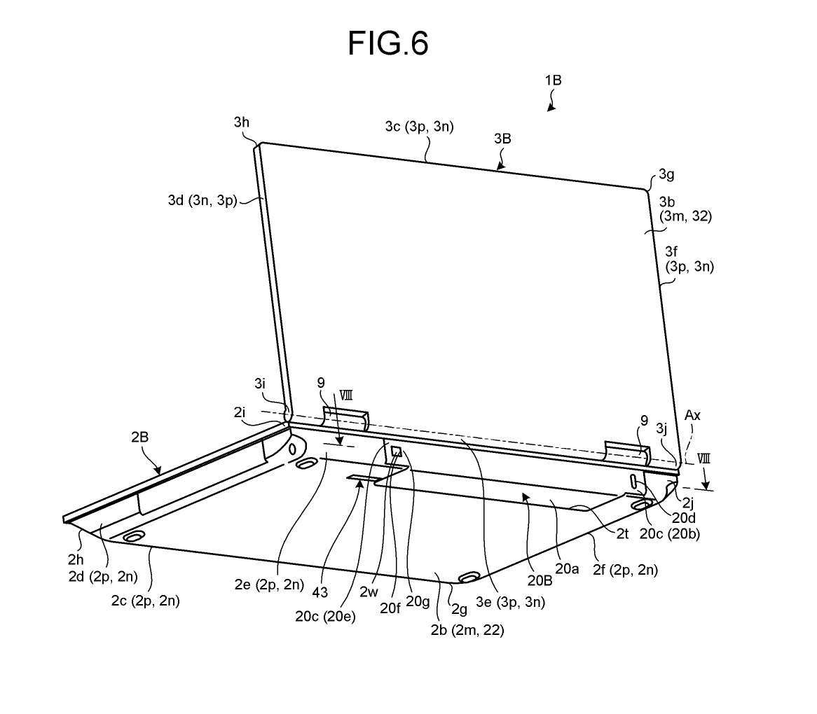

In a second embodiment, as an example, an electronic device 1B comprises a first housing 3B and a second housing 2B, as illustrated in FIGS. 5 and 6. To be more specific, the first housing 3B (a first portion) houses at least a portion of the display device 4. The first housing 3B is provided with the transparent touch panel 5 (a touch sensor, an input operation portion, an input receiver, an input portion) overlapped with the display device 4. A user, for example, can visually recognize images (pictures) displayed on the display screen 4a of the display device 4 through the touch panel 5.

As illustrated in FIG. 5, the second housing 2B (a second portion) houses a substrate 6. The second housing 2B is provided with a keyboard 7 (an input operation portion, a first input operation portion, an input receiver, an input portion), a pointing device 8a (an input operation portion, a second input operation portion, an input receiver, an input portion), click buttons 8b (input operation portions, input receivers, input portions), etc.

The first housing 3B and the second housing 2B are connected to each other in a rotatable manner with a hinge mechanism 9 (a hinge, a connecting portion, a connector, a rotatable support portion, a connecting mechanism, a connector mechanism, a rotatable support mechanism). The first housing 3B and the second housing 2B are connected to each other in a rotatable manner with the hinge mechanism 9 between an open state illustrated in FIGS. 5 and 6 and a folded state (not illustrated). In the second embodiment, as an example, the hinge mechanism 9 connects the first housing 3B and the second housing 2B in a rotatable manner around a rotation axis Ax.

The display screen 4a of the display device 4 can be visually recognized through the opening 3r provided on the face 3a (an anterior face, an upper face, a front face, a face portion) of the first housing 3B. The keyboard 7, the pointing device 8a, the click buttons 8b, etc., are exposed on a face 2a (an anterior face, an upper face, a front face, a face portion) of the second housing 2B. In the folded state, the face 3a of the first housing 3B and the face 2a of the second housing 2B are overlapped with each other, and the display screen 4a, the keyboard 7, the pointing device 8a, the click button 8b, etc., are hidden by the first housing 3B and the second housing 2B. In the open state, the face 3a of the first housing 3B and the face 2a of the second housing 2B are exposed, and the display screen 4a, the keyboard 7, the pointing device 8a, the click buttons 8b, etc., become available (visually recognizable or operational). One side of the first housing 3B in a thickness direction may be covered by a face of the touch panel. In this case, the face of the touch panel is a face of the first housing. The second housing 2B may be provided with a display device having a touch panel (not illustrated) instead of the keyboard. Furthermore, one side of the second housing 2B in a thickness direction may be covered by a face of the touch panel. In this case, the face of the touch panel is a face of the second housing.

In the second embodiment, as an example, the first housing 3B is quadrangular (rectangular as an example in the second embodiment) in a front view and a rear view, as illustrated in FIGS. 5 and 6. In the second embodiment, as an example, the first housing 3B is thin flat rectangular parallelepiped. The first housing 3B has the face 3a, and the opposite face 3b (a back face, an under face, a rear face, a face portion). The face 3a and the face 3b are nearly parallel. As illustrated in FIGS. 5 and 6, the first housing 3B has four ends 3c to 3f (sides, edges), and four corners 3g to 3j (apexes, curves, ends) in a front view. The ends 3c and 3e are examples of long sides, while the ends 3d and 3f are examples of short sides.

The first housing 3B has the wall 3k (a portion, a plate, a frame, a front wall, a surface wall, a top wall) having the face 3a, and the wall 3m (a portion, a plate, a back wall, a rear wall, a bottom wall) having the face 3b. The walls 3k and 3m are quadrangular (rectangular as an example in the second embodiment). The first housing 3B has four walls 3n (portions, plates, side walls, end walls, standing walls, extending portions) that have the face 3p (a side face, a periphery face) extending between the wall 3k and the wall 3m. The wall 3k is provided with the quadrangular opening 3r, for example. Thus, the wall 3k is quadrangular and is of frame.

The first housing 3B can be constituted by a combination of a plurality of components (divided bodies). In the second embodiment, as an example, the first housing 3B comprises a first housing member 31 (a first portion, a front-side member, a mask, a mask portion, a cover, a front cover, a cover portion, a first area) having at least the wall 3k, and a second housing member 32 (a second portion, a back-side member, a base, a base portion, a bottom, a bottom portion, a cover, a rear cover, a cover portion, a second area) having at least the wall 3m. The wall 3n is included in at least one of the first housing member 31 and the second housing member 32 (in the second housing member 32, for example). Separately from the first housing member 31 and the second housing member 32, the first housing 3B can comprise a third housing member (a third portion, an intermediate member, a spacing member, a barrier member, a wall member, an interposed member, an inner plate, a middle plate, a middle frame, a third area (not illustrated)), a fourth housing member (a fourth portion, an intermediate member, a spacing member, a barrier member, a wall member, an interposed member, a cover member, a shield, a fourth area (not illustrated)), and other members that are interposed between the housing members 31, 32. The first housing 3B can be formed of metallic or synthetic resin material, for example.

In the second embodiment, as an example, a display screen 4a positioned on the side of the face 3a of the display device 4 (a display portion, a display, a panel) is exposed to the front side (outside) of the first housing 3B through the opening 3r. A user, for example, can visually recognize the display screen 4a through the opening 3r from the front side. The display device 4 is quadrangular (rectangular as an example in the second embodiment) in a front view. The display device 4 is thin flat rectangular parallelepiped in a front-back direction. The display device 4 is an LCD, or an GELD, for example.

In the second embodiment, as an example, on the front side (the surface side, the side of the wall 3k) of the display device 4, the touch panel 5 (an input operation panel, a touch sensor, an operation face, a cover, for example) is provided. The touch panel 5 is transparent relatively-thin quadrangular, and covers the display screen 4a. An operator (a user, for example) touches, pushes, rubs the touch panel 5 with a finger, a piece (a stylus, for example (not illustrated)), etc., or moves a finger, a stylus, etc., in the vicinity of the touch panel 5, for example, so as to perform input processing. The light emitted from the display screen 4a of the display device 4 passes through the touch panel 5, and is then let out to the front side (outside) of the first housing 3B through the opening 3r of the wall 3k.

In the second embodiment, as an example, the second housing 2B is quadrangular (rectangular as an example in the second embodiment) in a front view and a rear view, as illustrated in FIGS. 5 and 6. In the second embodiment, as an example, the second housing 2B is thin flat rectangular parallelepiped. The second housing 2B has the face 2a, and an opposite face 2b (a back face, an under face, a rear face, a face portion). The face 2a and the face 2b are nearly parallel. In a front view of the face 2a, the second housing 2B has four ends 2c to 2f (sides, edges), and four corners 2g to 2j (apexes, curves, ends). The ends 2c and 2e are examples of long sides, while the ends 2d and 2f are examples of short sides.

The second housing 2B has a wall 2k (a portion, a plate, a frame, a front wall, a surface wall, a top wall) having the face 2a, and a wall 2m (a part, a plate, a back wall, a rear wall, a bottom wall) having the face 2b. The walls 2k and 2m are quadrangular (rectangular as an example in the second embodiment). The second housing 2B has four walls 2n (portions, plates, side walls, end walls, standing walls, extending portions) that have a face 2p (a side face, a periphery face) extending between the wall 2k and the wall 2m. The wall 2k is provided with a quadrangular opening 2r, for example. Thus, the wall 2k is quadrangular and is of frame.

As an example, the second housing 2B can be configured by a combination of a plurality of components (divided bodies). In the second embodiment, as an example, the second housing 2B comprises a first housing member 21 (a first portion, a front-side member, a mask, a mask portion, a cover, a front cover, a cover portion, a first area) having at least the wall 2k, and a second housing member 22 (a second portion, a back-side member, a base, a base portion, a bottom, a bottom portion, a cover, a rear cover, a cover portion, a second area) having at least the wall 2m. The walls 2n are included in at least one of the first housing member 21 and the second housing member 22 (in the second housing member 22, for example). Separately from the first housing member 21 and the second housing member 22, the second housing 2B can comprise a third housing member (a third portion, an intermediate member, a spacing member, a barrier member, a wall member, an interposed member, an inner plate, a middle plate, a middle frame, a third area (not illustrated)), a fourth housing member (a fourth portion, an intermediate member, a spacing member, a barrier member, a wall member, an interposed member, a cover member, a shield, a fourth area (not illustrated)), and other members that are interposed between the housing members 21, 22. The second housing 2B can be formed of metallic or synthetic resin material, for example.

In the second embodiment, as an example, an operation face 7a (a face, an upper face) of the keyboard 7 is exposed to the front side (the outside) of the second housing 2B through the opening portion 2r. On the face 2a, the keyboard 7 is positioned nearer to the side of the end 2e, while the pointing device 8a and the click buttons 8b are arranged nearer to the side of the end 2c opposite the end 2e. The end 2e is positioned on the back side in a horizontal depth direction (front-back direction), while the end 2c is positioned on the near side.

In the second embodiment, as an example, the second housing 2B houses, on the back side (the reverse side, the rear side, the side of the wall 2m, the side opposite the operation face 7a) of the keyboard 7, one or more substrate 6 (a circuit board, a control board, a main board, an electrical component, a first electrical component). The substrate 6 is provided in parallel with the keyboard 7. The substrate 6 is spaced from the walls 2k, 2m, 2n, etc., that is, the substrate 6 is provided with space (gaps) from the walls 2k, 2m, 2n, etc.

In the second embodiment, as an example, a plurality of components (not illustrated) such as a CPU, a graphic controller, power circuit components, a PCH, a memory slot connector, an LCD connector, an I/O connector, a power coil, an element, and a connector, can be mounted on the substrate 6. A control circuit can comprise an image signal processing circuit, a tuner, an HDMI signal processor, an AV input terminal, a remote control signal receiving module, a controller, a selector, an on-screen display interface, a memory (a ROM, a RAM, an HDD, or an SSD, for example), a voice signal processing circuit, etc. The control circuit controls the output of images (moving images, still images, etc.) on the display screen 4a of the display device 4, the output of voice from a speaker (not illustrated), the emission of light from an LED, etc. The display device 4, the speaker, the LED, etc., are examples of an output module.

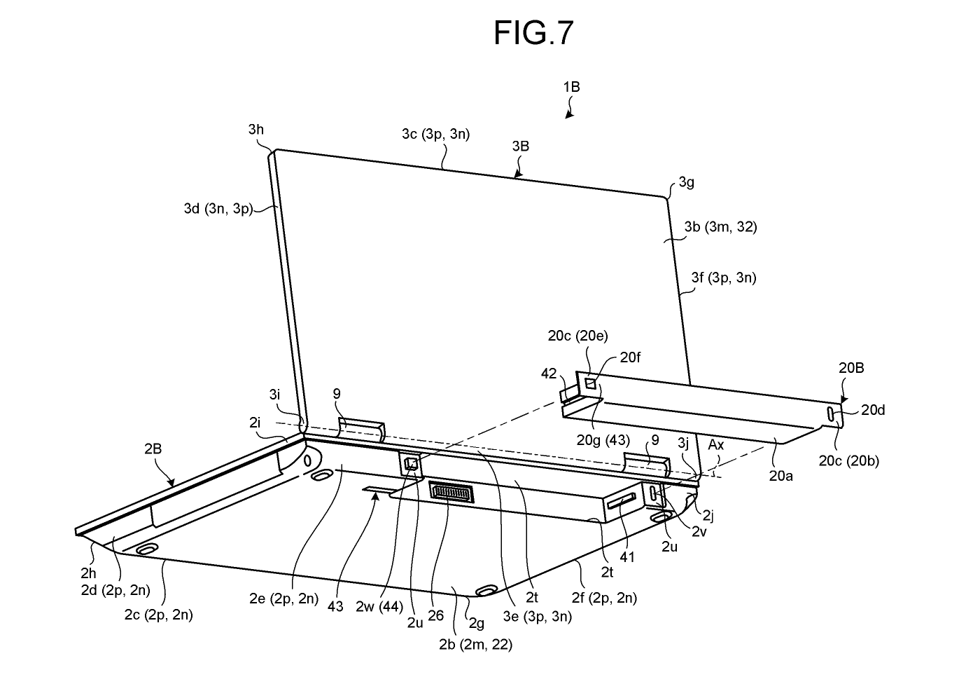

In the second embodiment, as an example, the second housing 2B is provided with a container 2t, as illustrated in FIGS. 6 to 8. To be more specific, the container 2t is provided, at the end 2e (the lower end) of the second housing 2B, as a notch open toward the side of the external carrying face 100a (downward). The container 2t extends along the end 2e. The container 2t houses a battery module 20B (a module, a first module) in a removable manner. The battery module 20B is rectangular parallelepiped (of square bar) extending along the end 2e. In the second embodiment, as an example, the battery module 20B can be attached to the container 2t by moving (inserting) it from the back side (the posterior, the rear-back side) to the near side (the front side, the anterior face side, the anterior) in FIG. 5, and can be removed from the container 2t by moving it in the opposite direction. In the second embodiment, as an example, as illustrated in FIG. 7, the container 2t (second housing 2B) and the battery module 20B are provided with a structure for guiding the battery module 20B to a given position (an attached position) in the container 2t (a guiding portion (a guiding protrusion 41, a guiding groove 42, etc., as examples in the second embodiment)), a lock structure 50 (a lock mechanism, a lock device) for locking the battery module 20B at the given position, and a lock cancel structure (a lock cancel mechanism, a lock cancel device) for cancelling a lock by the lock structure 50.

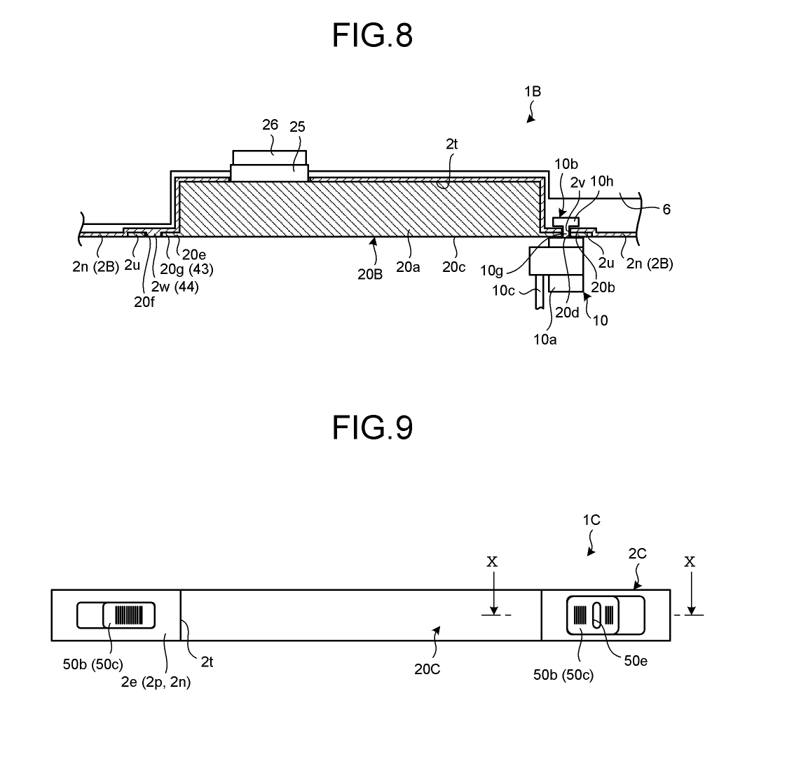

Also in the second embodiment, as an example, similarly to the first embodiment, openings 2v and 20d are provided at a portion where the wall 2n of the second housing 2B and the wall 20b of the battery module 20B positioned outside of the housing of the wall 2n overlap each other, as illustrated in FIG. 8. Then, the connecting member 10b passes through the openings 2v and 20d, so that the connecting device 10 is connected to the second housing 2B and locked thereto in a state that the battery module 20B is housed in the container 2t. Therefore, also in the second embodiment, as an example, it is possible, with the connecting device 10, to prevent the movement of the second housing 2B (electronic device 1B) and prevent the battery module 20B from being taken out from (coming off) the container 2t. The battery module 20B has a connector 25, and is electrically connected to a connector 26 of the second housing 2B in a state that the battery module 20B is housed in the container 2t. The connector 26 is provided on the substrate 6 (see FIG. 5), for example.

In the second embodiment, as an example, the wall 20b (a flange portion, a projecting portion, a second wall) extending from the housing 20a (a support portion, a body, a body portion, a first portion) of the battery module 20B along the end 2e (wall 2n) is overlapped with the outside (the outside of the housing, the rear side) of the wall 2n (a first wall) of the second housing 2B, as illustrated in FIGS. 7 and 8. The wall 2n is provided with a depressed portion 2u (a container, a step) housing the wall 20b. With this arrangement, there hardly exist a level difference between the face 2p and the face 20c. The openings 2v and 20d through which the connecting member 10b is passed are provided at a portion where the wall 2n and the wall 20b overlap each other.

In the second embodiment, as an example, guiding portions 43, 44 are provided at positions separated from the openings 2v and 20d (on the side opposite to openings 2v and 20d of the housing 20a, as an example in the second embodiment), as illustrated in FIGS. 6 to 8. To be more specific, the battery module 20B is provided with a wall 20e extending along the end 2e (wall 2n) on the side opposite the wall 20b of the housing 20a, and the wall 20e is overlapped with the wall 2n. The wall 2n is provided with the recessed portion 2u housing the wall 20e. That is, there hardly exist a level difference between the face 2p and the face 20c even at a position where the wall 20e is provided. On the wall 20e, an opening 20f is provided. A projecting portion 2w to be inserted into the opening 20f is provided at a portion where the opening 20f overlaps with the wall 20e of the wall 2n. The opening 20f is quadrangular, and the projecting portion 2w is of relatively-low prism. The opening 20f and a periphery 20g are examples of the guiding portion 43, and the projecting portion 2w is an example of the guiding portion 44. Therefore, in the second embodiment, as an example, it is possible to prevent an increase (concentration) of stress at the wall 20b, a boundary portion between the wall 20b and the housing 20a, etc., due to external force exerted when the battery module 20B is attached or removed, external force exerted from the connecting device 10, etc. In the second embodiment, as an example, the battery module 20B is supported by the second housing 2B at the both ends with the wall 20b and the wall 20e. Therefore, as an example, the battery module 20B can be supported stably by the second housing 2B.

Also in the second embodiment, the same results (effects) based on the same structure as the above-mentioned other embodiment can be obtained. In the second embodiment, as an example, the second housing 2B has the guiding portion 44 for guiding the battery module 20B at a position separated from the opening 2v. Therefore, in the second embodiment, as an example, the battery module 20B can be supported more stably. In addition, as an example, it is easier to prevent a local increase of stress in the battery module 20B. In the second embodiment, as an example, the guiding portion 44 is positioned on the side opposite the opening 2v of the container 2t (housing 20a), and the guiding portion 44 is provided on the wall 20e provided on the side opposite the wall 20b of the housing 20a. Therefore, in the second embodiment, as an example, it is easier to support the battery module 20B more stably, and it is easier to prevent a local increase of stress in the battery module 20B more effectively.

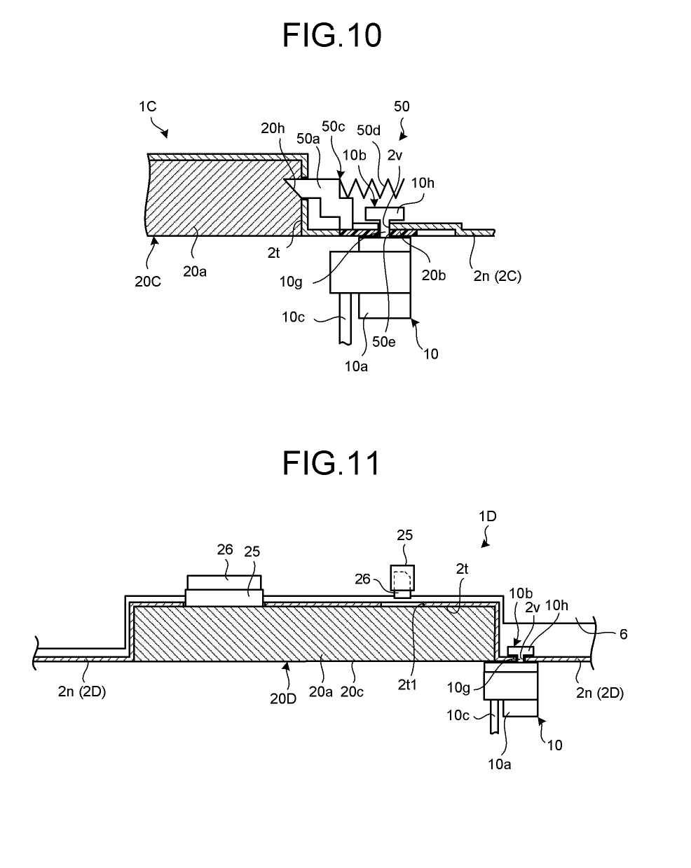

In a third embodiment, as an example, a second housing 2C is provided with a lock structure 50 for locking a battery module 20C (a lock cancel structure, a lock mechanism, a lock cancel mechanism, a lock device, a lock cancel device), as illustrated in FIGS. 9 and 10. To be more specific, the lock structure 50 comprises a lock member 50c (a movable portion) composed of an integrated combination of a hook 50a (a hanging portion, a projecting portion, a support portion, an engaging portion, a pawl) and an operator 50b (an operation portion, a slider), and an elastic member 50d (a coil spring as an example) biasing the lock member 50c. The lock member 50c is supported by the second housing 2C in a movable (reciprocable) manner along the end 2e. The hook 50a is pushed by the elastic member 50d and thus inserted into a depressed portion 20h arranged at the battery module 20C, so that the battery module 20C is locked in a state that it is housed in the container 2t.

In the third embodiment, as an example, the operator 50b is provided with an opening 50e. The opening 50e overlaps with the opening 2v provided on the wall 2n of the second housing 2C at a position where the lock member 50c depicted in FIGS. 9 and 10 locks the battery module 20C in a state that the battery module 20C is housed in the container 2t. The connecting member 10b of the connecting device 10 passes through the opening portions 2v and 50e, and the wall 2n and the operator 50b (lock member 50c) are sandwiched between the pawl 10h and the housing 10a. That is, also in the third embodiment, as an example, it is possible, with the connecting device 10, to prevent the movement of the second housing 2C (electronic device 1C) and prevent the battery module 20C from being removed from (coming off) the container 2t. Also in the third embodiment, the same results (effects) based on the same structure as the above-mentioned other embodiments can be obtained.

In a fourth embodiment, as an example, a portion of the housing 10a of the connecting device 10 is positioned at an outer side (in a removal direction) from a housing position of a battery module 20D in a state in which the battery module 20D is housed in the container 2t of a second housing 2D, as illustrated in FIG. 11. This arrangement prevents the battery module 20D from coming out from the container 2t. That is, also in the third embodiment, as an example, it is possible, with the connecting device 10, to prevent the movement of the second housing 2D (electronic device 1D) and prevent the battery module 20D from being taken out from (coming off) the container 2t. Furthermore, the second housing 2D is provided with an opening 2t1 facing the container 2t. The connector 25 (a support portion, a holder, a socket, a housing) provided on the inner side of the housing of the opening portion 2t1 supports a card 26 (a media, a module, a component, an electronic component (a subscriber identity module (SIM) card as an example)) in a removable manner. The card 26 is taken out through the opening portion 2t1 and the container 2t. In a state in which the battery module 20D is housed in the container 2t, the card 26 is hidden by the battery module 20D. Thus, the connecting device 10 prevents the card 26 from being removed from (coming off) the connector 25. Also in the fourth embodiment, the same results (effects) based on the same structure as the above-mentioned other embodiments can be obtained.

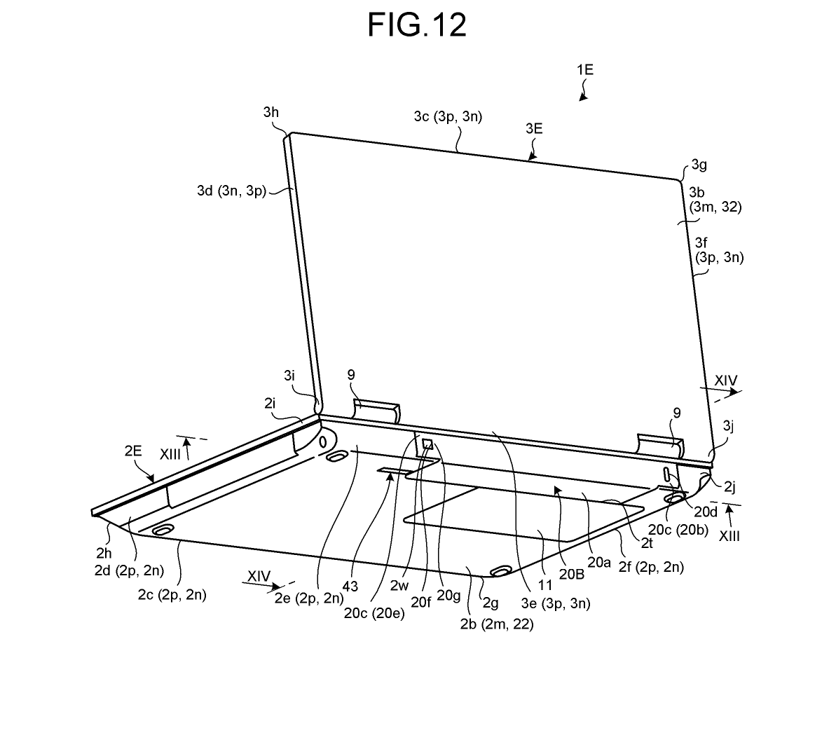

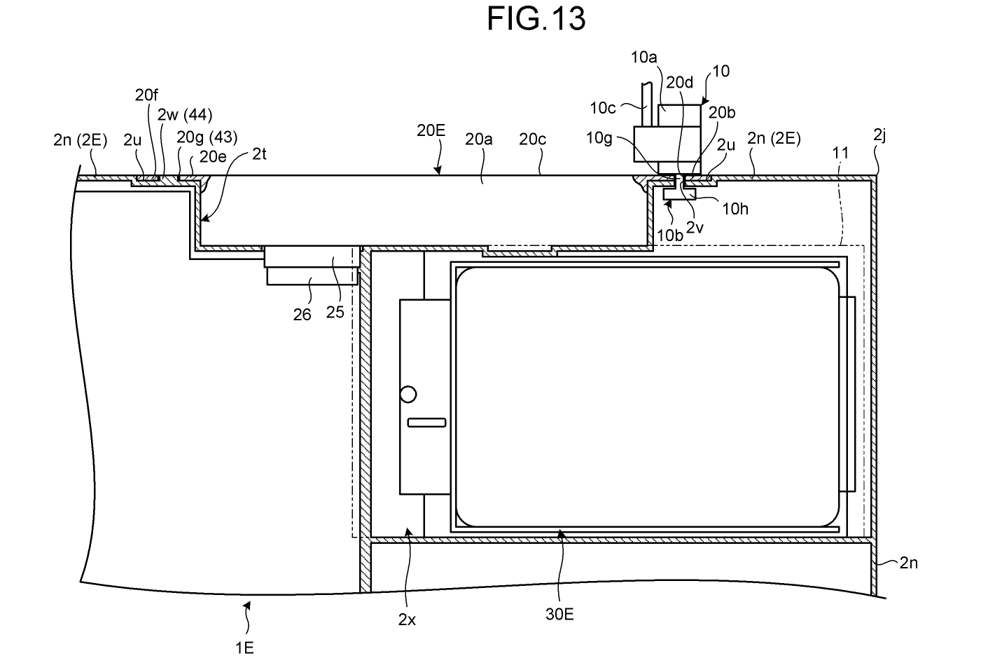

In a fifth embodiment, as an example, a container 2x (a second housing) is provided adjacent to the container 2t of a battery module 20E in a second housing 2E, as illustrated in FIGS. 12, 13. The container 2x houses a second module 30E same as the above-mentioned other embodiment in a removable manner. In the fifth embodiment, as an example, the container 2x is formed as a depressed portion (an opening, space, a gap) opening on the face 2b of the second housing 2E. The container 2x is covered by a cover 11 (a cover member, a cover member, a prevention member) in a removable manner. The structure in which the battery module 20E is attached and locked to the second housing 2E is the same as in the second embodiment.

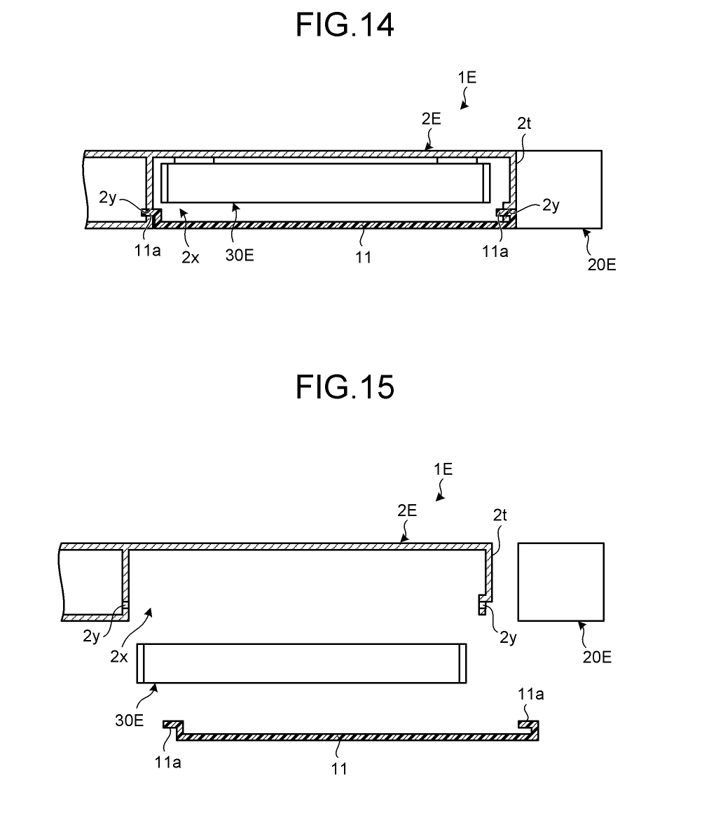

However, in the fifth embodiment, as an example, the cover 11 is configured so that it is not removed unless the battery module 20E is removed from the container 2t (so that it can be attached or removed in a state in which the battery module 20E is removed (the battery module does not exist, the battery module is separated)). That is, the battery module 20E blocks at least a part of a removal path (a moving path, an attaching-removing path) of the cover 11 so as to prevent the removal of the cover 11 and lock the cover 11 in a fixed state (an attached state, a covering state). To be more specific, as illustrated in FIGS. 14 and 15, the second module 30E is removed (coming off) toward the lower side of FIGS. 14 and 15. The cover 11 is positioned on the lower side in FIGS. 14 and 15 of the second module 30E, and covers the second module 30E from the lower side of FIGS. 14 and 15. That is, the cover 11 blocks a removal path of the second module 30E so as to prevent the removal of the second module 30E. The cover 11 is attached to the second housing 2E from the right side of FIGS. 14 and 15. That is, the cover 11 has hooks 11a (hanging portions, pawls, support portions, attaching portions, connecting portions), and the hooks 11a are inserted into opening portions 2y provided on the second housing 2E from the right side of FIGS. 14 and 15. The battery module 20E is positioned on the right side in FIGS. 14 and 15 of the cover 11 attached on the second housing 2E. The battery module 20E is locked by the connecting device 10 in a state that the battery module 20E is housed in the container 2t. Therefore, also in the fifth embodiment, as an example, it is possible, with the connecting device 10, to prevent the movement of the second housing 2E (electronic device 1E), prevent the battery module 20E from being removed from (coming off) the container 2t, and prevent the second module 30E from being removed from (coming off) the container 2x. Also in the fifth embodiment, the same results (effects) based on the same structure as the above-mentioned other embodiments can be obtained.

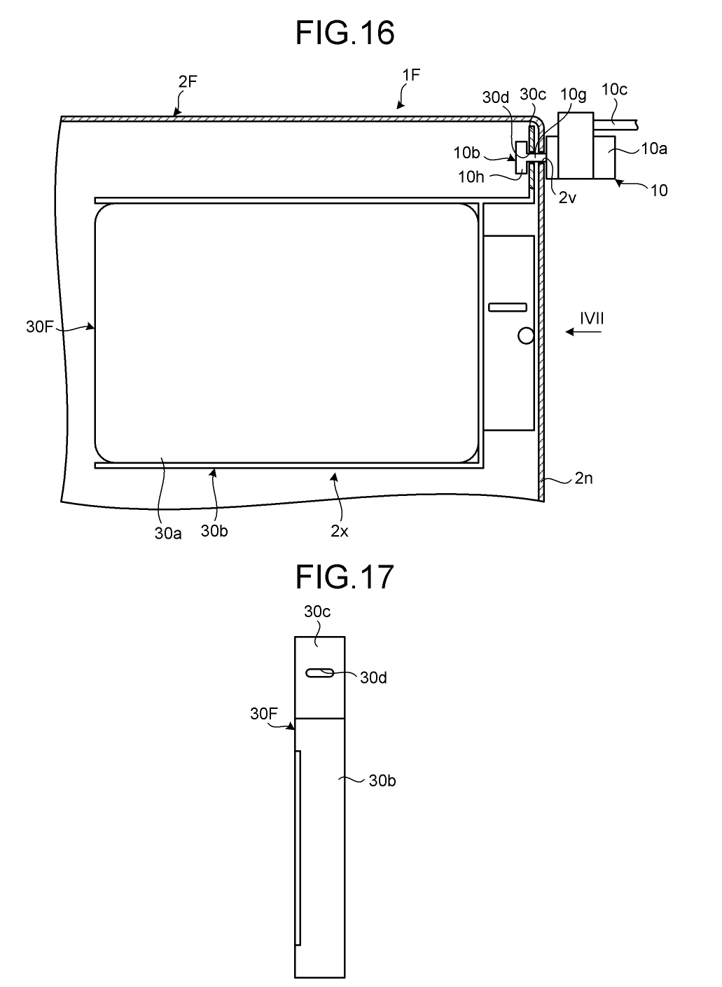

In a sixth embodiment, as an example, it is possible, with the connecting device 10, to prevent the movement of a second housing 2F (electronic device 1F) and prevent a second module 30F (assembly) same as in the above-mentioned other embodiments from being removed from (coming off) the container 2x in the second housing 2F, as illustrated in FIGS. 16 and 17. To be more specific, the second module 30F comprises a housing 30a (a body, a body portion, a fixing portion, a first portion, a module, an electrical component), and a holder 30b (a supporting member, a support member, a bracket, a member). The holder 30b is formed of a plate member, and has a wall 30c facing the inner side (the inner side of the housing) of the wall 2n of the second housing 2F. The walls 2n and 30c overlapping each other are provided with the openings 2v and 30d, respectively, overlapping each other. As an example, the opening 30d (a second opening) is provided in long slotted form similarly to the openings through which the connecting member 10b passes in the above-mentioned other embodiments, as illustrated in FIG. 17. The connecting member 10b of the connecting device 10 passes through the openings 2v and 30d, and the walls 2n and 30c are sandwiched between the pawl 10h and the housing 10a. Therefore, also in the sixth embodiment, as an example, it is possible, with the connecting device 10, to prevent the movement of the second housing 2F (electronic device 1F) and prevent the second module 30F from being removed from (coming off) the container 2x. Also in the sixth embodiment, the same results (effects) based on the same structure as the above-mentioned other embodiments can be obtained.

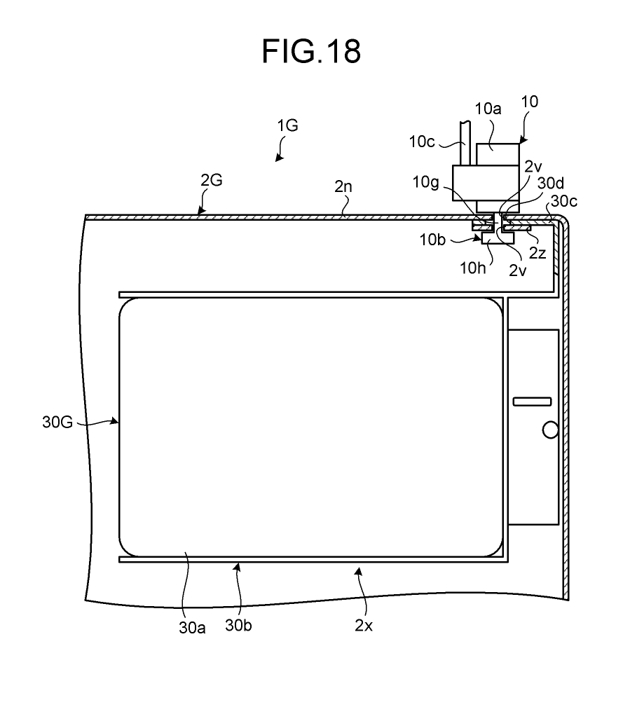

Also in a seventh embodiment, similarly to the sixth embodiment, as an example, it is possible, with the connecting device 10, to prevent the movement of a second housing 2G (electronic device 1G) and prevent a second module 30G same as in the above-mentioned other embodiments from being removed from (coming off) the container 2x in the second housing 2G, as illustrated in FIG. 18. However, in the seventh embodiment, the wall 2n on which the opening 2v is provided is different from in the sixth embodiment. Thus, the structure of the holder 30b (wall 30c) is different from in the sixth embodiment. In the seventh embodiment, as an example, the second housing 2G is provided with a wall 2z (a rib, a projecting portion, a protrusion, a third wall) on the side opposite the wall 2n on the wall 30c of the holder 30b. The wall 30c is sandwiched between the wall 2n and the wall 2z. The wall 2z is also provided with an opening 2v1 (a third opening) through which the connecting member 10b is passed. The opening 30d provided on the wall 30c is larger than the openings 2v and 2v1. The connecting member 10b of the connecting device 10 passes through the openings 2v, 30d, and 2v1, and the walls 2n, 30c, and 2z are sandwiched between the pawl 10h and the housing 10a. Therefore, in the seventh embodiment, as an example, it is possible, with the connecting device 10, to prevent the movement of the second housing 2G (electronic device 1G) and prevent the second module 30G from being removed from (coming off) the container 2x. However, in the seventh embodiment, as an example, the wall 30c of the second module 30G is sandwiched between the two walls 2n and 2z of the second housing 2G. The opening 30d on the wall 30c is larger than the openings 2v and 2v1 on the walls 2n and 2z, respectively. Thus, in the seventh embodiment, as an example, it is difficult that external force (load, impact load, etc.) acts directly on the second module 30G from the connecting member 10b of the connecting device 10. Therefore, in the seventh embodiment, as an example, it is easier to prevent the damage of the second module 30G due to force exerted on the connecting device 10, and the occurrence of electric abnormal processing (read-write errors, for example). Furthermore, in the seventh embodiment, as an example, it is easier, with the wall 2z, to increase rigidness of a part at which the connecting device 10 is connected, when the wall 2n is formed of synthetic resin material, for example. As an example, the wall 2z is formed of materials stronger (harder to bend, solider, higher in rigidness) than those of the wall 2n, which makes it easier to achieve both weight saving of the second housing 2G and high rigidness thereof relative to the connecting device 10. Also in the seventh embodiment, the same results (effects) based on the same structure as the above-mentioned other embodiments can be obtained.

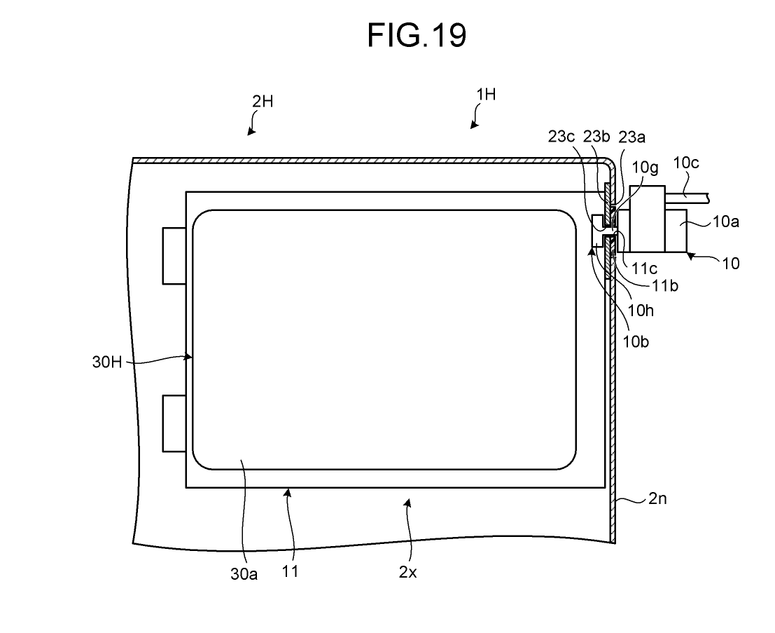

Also in an eighth embodiment, similarly to the sixth embodiment, as an example, it is possible, with the connecting device 10, to prevent the movement of a second housing 2H (electronic device 1H) and prevent a second module 30H same as in the above-mentioned other embodiments from being removed from (coming off) the container 2x in the second housing 2H, as illustrated in FIG. 19. However, in the eighth embodiment, the cover 11 preventing the second module 30H from being removed from (coming off) the container 2x is prevented from being removed from the second housing 2H. To be more specific, an opening 23a (a notch, a recessed portion) is provided on a portion of the wall 2n of the second housing 2H, and a wall 11b of the cover 11 is housed in the opening 23a. A wall 23b of the second housing 2H is provided on the back side of the opening 23a. The wall 23b is positioned on the inner side (the inner side of the housing) from the wall 2n. A step is formed between the wall 23b and the wall 2n. The wall 11b of the cover 11 and the wall 23b of the second housing 2H overlap each other. The walls 23b and 11b overlapping each other are provided with openings 23c and 11c, respectively, overlapping each other. The connecting member 10b of the connecting device 10 passes through the openings 23c and 11c, and the walls 23b, 11b are sandwiched between the pawl 10h and the housing 10a. That is, in the eighth embodiment, as an example, it is possible, with the connecting device 10, to prevent the movement of the second housing 2H (electronic device 1H), prevent the cover 11 from being removed from (coming off) the second housing 2H, and prevent the second module 30H from being removed from (coming off) the container 2x. Also in the eighth embodiment, similarly to the seventh embodiment, the wall 23b is formed of materials stronger (harder to bend, solider, higher in rigidness) than those of the wall 2n, which makes it easier to achieve both weight saving of the second housing 2H and high rigidness thereof relative to the connecting device 10. The wall 23b may be provided so as to extend over the opening portion 23a on the wall 2n, or so as to project from another wall (wall 2m or wall 2k, for example). Also in the eighth embodiment, the same results (effects) based on the same structure as the above-mentioned other embodiments can be obtained.

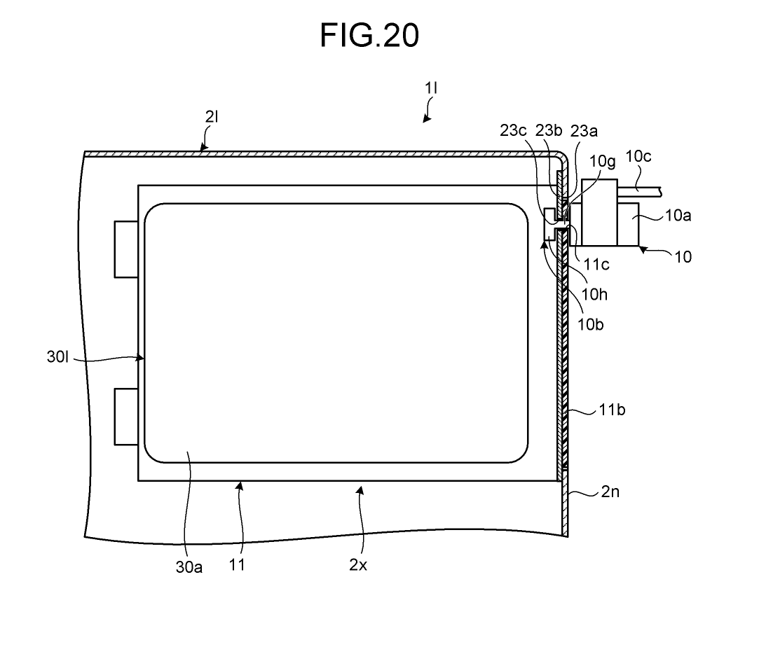

The configuration in a ninth embodiment is the same as in the eighth structure. That is, it is possible, with the connecting device 10, to prevent the movement of a second housing 2I (electronic device 1I) and prevent a second module 30I same as in the above-mentioned other embodiments from being removed from (coming off) the container 2x in the second housing 2I. However, in the ninth embodiment, as an example, the width of the wall 11b is larger than in the eighth embodiment, as illustrated in FIG. 20. Thus, it is possible to attach or remove the second module 30I from the side of the wall 11b (the right side of FIG. 20). Also in the ninth embodiment, the same results (effects) based on the same structure as the above-mentioned other embodiments can be obtained.

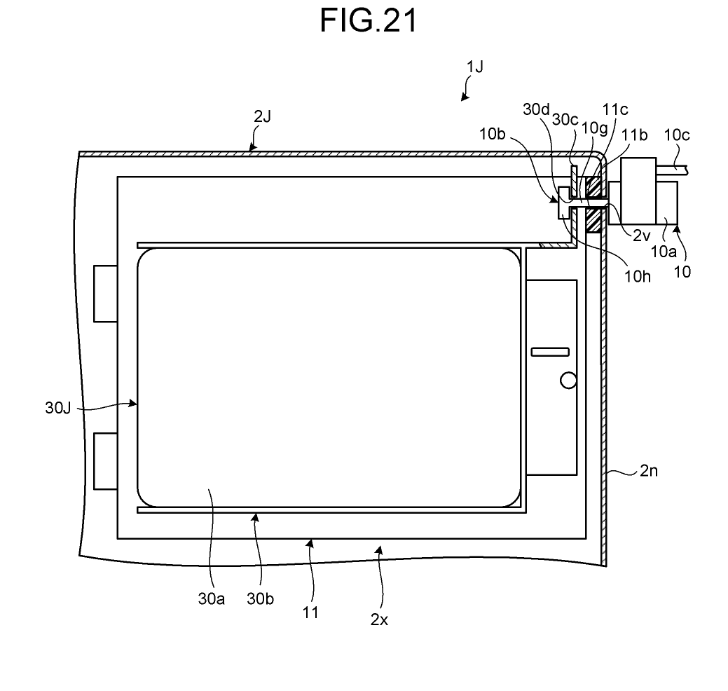

Also in a tenth embodiment, similarly to the sixth embodiment, as an example, it is possible, with the connecting device 10, to prevent the movement of a second housing 2J (electronic device 1J) and prevent a second module 30J same as in the above-mentioned other embodiments from being removed from (coming off) the container 2x in the second housing 2J, as illustrated in FIG. 21. However, in the tenth embodiment, the wall 30c of the holder 30b, the wall 11b of the cover 11, and the wall 2n of the second housing 2J overlapping one another are provided with the opening portions 30d, 11c, and 2v, respectively, overlapping one another. The connecting member 10b of the connecting device 10 passes through the openings 30d, 11c, and 2v, and the walls 30c, 11b, and 2n are sandwiched between the pawl 10h and the housing 10a. That is, in the tenth embodiment, as an example, it is possible, with the connecting device 10, to prevent the movement of the second housing 2J (electronic device 1J), prevent the cover 11 from being taken out from (coming off) the second housing 2J, and prevent the second module 30J from being removed from (coming off) the container 2x. Also in the tenth embodiment, the same results (effects) based on the same structure as the above-mentioned other embodiments can be obtained.

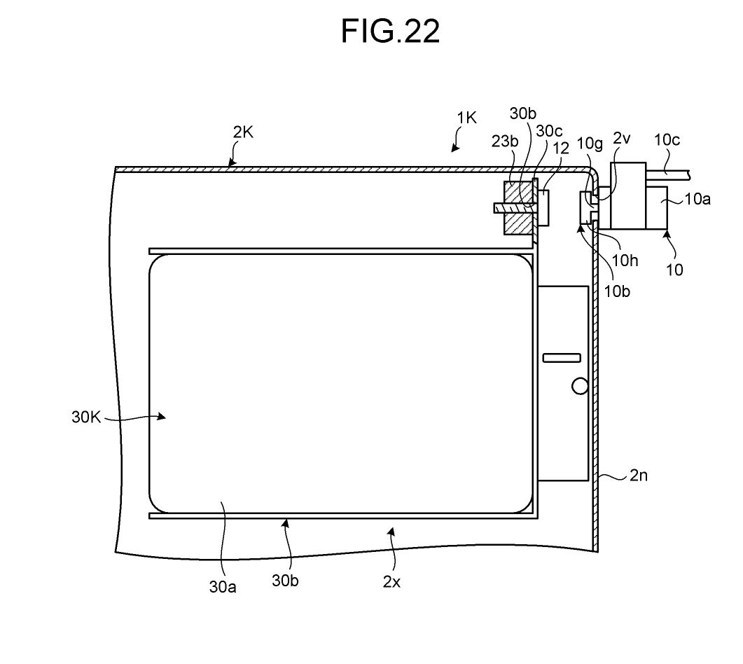

Also in an eleventh embodiment, similarly to the sixth embodiment, as an example, it is possible, with the connecting device 10, to prevent the movement of a second housing 2K (electronic device 1K) and prevent a second module 30K same as in the above-mentioned other embodiments from being removed from (coming off) the container 2x in the second housing 2K, as illustrated in FIG. 22. However, in the tenth embodiment, concretely, the holder 30b is fixed to the wall 23b provided to the second housing 2K. The holder 30b is fixed to the wall 23b with a fastener 12 (a fixture, a prevention member). The opening 2v on the wall 2n of the second housing 2K functions also as the opening 2v for a tool for attaching or removing the fastener 12. That is, in the eleventh embodiment, as an embodiment, the connecting device 10 covers (blocks) at least a portion of the opening 2v for removing the fastener 12. That is, in the eleventh embodiment, as an example, it is possible, with the connecting device 10, to prevent the movement of the second housing 2K (electronic device 1K) and prevent the second module 30K from being removed from (coming off) the container 2x. The wall 23b can be provided so as to project from any one of the walls (walls 2m, 2k, and 2n, for example) of the second housing 2K. Also in the eleventh embodiment, the same results (effects) based on the same structure as the above-mentioned other embodiments can be obtained.

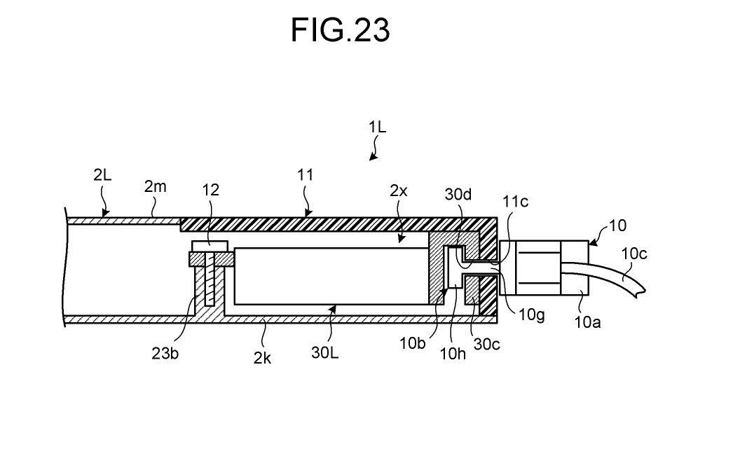

Also in a twelfth embodiment, similarly to the sixth embodiment, as an example, it is possible, with the connecting device 10, to prevent the movement of a second housing 2L (electronic device 1L) and prevent a second module 30L same as in the above-mentioned other embodiments from being taken out from (coming off) the housing 2x in the second housing 2L, as illustrated in FIG. 23. However, in the twelfth embodiment, concretely, the holder 30b and the wall 11b of the cover 11 overlapping each other are provided with the openings 30d and 11c, respectively, overlapping each other. The connecting member 10b of the connecting device 10 passes through the opening portions 30d and 11c, and the walls 30c and 11b are sandwiched between the pawl 10h and the housing 10a. The second module 30L is fixed to the wall 23b of the second housing 2L, etc., with the fastener 12, for example. FIG. 23 illustrates that a part of the second module 30L (holder 30b) and a portion of the cover 11 (wall 11b) constitute the wall of the second housing 2L. That is, in the twelfth embodiment, as an example, it is possible, with the connecting device 10, to prevent the movement of the second housing 2L (electronic device 1L) and prevent the second module 30L from being removed from (coming off) the container 2x. In addition, in the twelfth embodiment, as an example, it is easier to simplify the structure of the second housing 2L (electronic device 1L). Also in the twelfth embodiment, the same results (effects) based on the same structure as the above-mentioned other embodiments can be obtained.

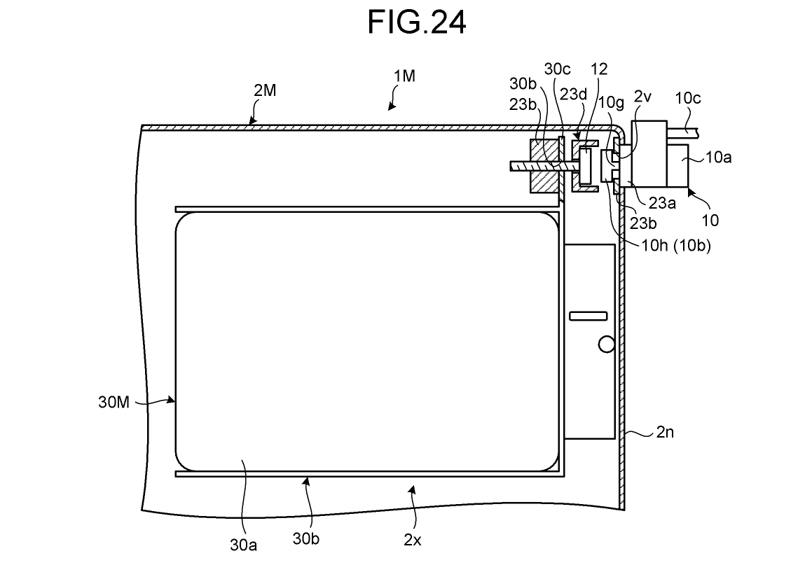

Also in a thirteenth embodiment, similarly to the sixth embodiment, as an example, it is possible, with the connecting device 10, to prevent the movement of a second housing 2M (electronic device 1M) and prevent a second module 30M same as in the above-mentioned other embodiments from being removed from (coming off) the container 2x in the second housing 2M, as illustrated in FIG. 24. The structure in the thirteenth embodiment is the same as in the eleventh embodiment. That is, in the thirteenth embodiment, as an example, the connecting device 10 covers (blocks) at least a part of the opening 2v for removing the fastener 12. However, in the thirteenth embodiment, as an example, similarly to the eighth embodiment, the opening 23a (a notch, a depressed portion) is provided on a part of the wall 2n of the second housing 2M, and the wall 23b of the second housing 2M is provided on the back side of the opening 23a. In the thirteenth embodiment, as an example, a guiding portion 23d (a support portion, a prevention portion) preventing the falling of the fastener 12 is provided in the second housing 2M. Therefore, in the thirteenth embodiment, as an example, it is easier to prevent the falling of the fastener 12 in the second housing 2M. Also in the thirteenth embodiment, the same results (effects) based on the same structure as the above-mentioned other embodiments can be obtained.

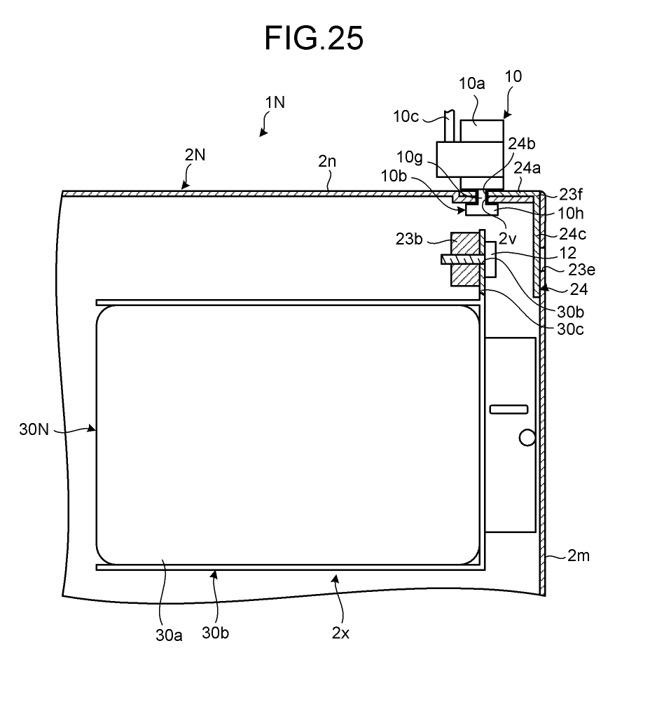

Also in a fourteenth embodiment, similarly to the sixth embodiment, as an example, it is possible, with the connecting device 10, to prevent the movement of a second housing 2N (electronic device 1N) and prevent a second module 30N same as in the above-mentioned other embodiments from being taken out from (coming off) the container 2x in the second housing 2N, as illustrated in FIG. 25. The structure in the fourteenth embodiment is the same as in the eleventh embodiment. That is, in the fourteenth embodiment, as an example, the connecting device 10 covers (blocks) at least a portion of the opening 2v for removing the fastener 12. However, in the fourteenth embodiment, as an example, a cover member 24 covering the opening 2v is provided. A wall 24a of the cover member 24 and the wall 2n of the second housing 2N overlapping each other are provided with openings 24b and 2v, respectively, overlapping each other. The connecting member 10b of the connecting device 10 passes through the openings 24b and 2v, and the walls 24a, 2n are sandwiched between the pawl 10h and the housing 10a. That is, in the fourteenth embodiment, as an example, the cover member 24 is locked to the second housing 2N with the connecting device 10. A wall 24c of the cover member 24 covers (blocks) at least a portion of an opening 23e for removing the fastener 12. That is, in the fourteenth embodiment, as an example, it is possible, with the connecting device 10, to prevent the movement of the second housing 2N (electronic device 1N) and prevent the second module 30N from being taken out from (coming off) the container 2x. In the fourteenth embodiment, as an example, the cover member 24 has the walls 24a and 24c, and has a bending form. The wall 24a is housed in the opening 23a provided on the wall 2n, and the wall 24c is inserted into the second housing 2N through an opening 23f provided on the wall 2n. Also in the fourteenth embodiment, the same results (effects) based on the same structure as the above-mentioned other embodiments can be obtained.

It is also possible to partially substitute the structure or form of each of the embodiments. The specification such as each structure or form (a structure, a kind, a direction, a form, a size, a length, a width, a thickness, a height, the number, arrangement, a position, a material, etc.) can be appropriately changed. The connecting device (lock device) is not limited to the disclosed ones, and may be a lock device such as a padlock or a component such a wire. The connecting device (lock device) may be one passing through a plurality of opening portions. The housing (a support portion, a body, a body portion) of the connecting device (lock device) fixed to the housing of the electronic device may be configured so as to prevent the movement of the lock member (movable portion) in the lock structure. Both of the first module and the second module can be constituted as other modules that can be attached to or removed from the housing.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A television receiver comprising:
a housing comprising a first wall comprising a first opening configured to allow an engaging member of a connecting device to pass through; and
a module removably housed in a container in the housing, the module comprising a second wall overlapping with the first wall, the module comprising a second opening overlapping with the first opening and configured to allow the engaging member to pass through,
wherein the housing is configured to allow the engaging member to be locked in the housing in a state in which the connecting device is connected to the housing and the module is housed in the container.

2. The television receiver of claim 1, wherein
the module further comprises:
an electrical component; and
a member attached to the electrical component and interposed between the electrical component and the housing, and
the second wall comprises the member.

3. The television receiver of claim 1, wherein the housing further comprises a third wall on a side of the second wall opposite the first wall and comprising a third opening configured to allow the engaging member to pass through.

4. The television receiver of claim 3, wherein the third opening is larger than the first opening.

5. The television receiver of claim 1, further comprising a second module removably housed in a second container in the housing, wherein
the module housed in the container is configured to lock the second module in the housing in a state in which the second module is housed in the second container.

6. The television receiver of claim 5, wherein the module is configured to prevent, when the module is housed in the container, a preventing member from being removed, the preventing member preventing the second module from coming out of the second container.

7. The television receiver of claim 6, wherein the preventing member is hidden by the module.

8. The television receiver of claim 6, wherein the preventing member is a cover member configured to cover a third opening for opening the second container.

9. The television receiver of claim 1, wherein the second wall comprises a lock member in the housing, the lock member being movable between a first position at which the module is locked in a state in which the module is housed in the container and a second position at which the module is unlocked.

10. An electronic device comprising:
a housing comprising a first wall comprising a first opening configured to allow a lock member of a lock device to pass through; and
a hard disk module removably housed in a container in the housing, comprising a second wall overlapping with the first wall and comprising a second opening overlapping with the first opening configured to allow the lock member to pass through, wherein
the lock device is connected to the housing and the hard disk module is prevented from coming out of the container.
